(19) United States
(12) Patent Application Publication
(10) Pub. No.: US 2008/0253871 A1
(43) Pub. Date: Oct. 16, 2008

(54) Robotic work cell and method of operation

(75) Inventor: Louis Bergeron, Saint-Flavien (CA)

Correspondence Address: OGILVY RENAULT LLP, 1981 MCGILL COLLEGE AVENUE, SUITE 1600, MONTREAL, QC, H3A2Y3, CA

(73) Assignee: Les Machineries Automatech Inc.

(21) Appl. No.: 11/783,458

(22) Filed: Apr. 10, 2007

(51) Int. Cl. B65G 1/00

(52) U.S. Cl. 414/281; 901/15

(57) ABSTRACT

A robotic work cell and a method of operation are described. The work cell is comprised of an industrial robot having at least one articulated robotic arm having a tool engaging end. A robot controller is associated with the robot to cause the robot to effect a programmed task selected from a plurality of programmed tasks stored in a computer memory. At least two or more fixed work stations are positioned in the work cell in proximity of the robot. At least two of the work stations have a work task platform detachably secured thereto with at least one of said platforms being a work task platform. The work platforms have a software associated therewith for the robot to effect an associated one of the programmed tasks on a product. The programmed task is one of a series of programmed tasks which are related and associated with a specific product to transform said product.

### TECHNICAL FIELD

The present invention relates to a robotic cell and a method of operation and more specifically, but not exclusively, to a robotic cell in which a robot is operated to perform one of a series of programmed tasks on work platforms, some of which are removably secured to specific ones of a plurality of fixed work stations in the immediate area of the robot.

### BACKGROUND ART

Currently industrial robots are used to perform fixed respective tasks such as welding of component parts together, cutting, drilling or routing a piece of material, such as wood, and the like wherein the robot always repeats a specific programmed task. The products which are usually worked on by the robot have a specific support structure capable of supporting the product at a precise location which is dedicated to the robot. Accordingly, these robots are set up to perform repetitive tasks. Accordingly, in a production run, once that specific task has been completed, the robot can be idled for a long period of time while awaiting a new product or whilst another robot performs another task on the same product whereby to eventually arrive at a final transformed product. When robots are used in long product transformation lines or assembly lines with large production volumes, each robot performs a specific task and is maintained occupied during the entire operation of the production runs, such as in the manufacture of automobiles. Therefore, the investment of robots in such production lines is quite feasible. However, because robots are fairly expensive, smaller manufacturers cannot afford the use of robots as their production runs do not justify the cost. There is therefore a need to resolve this problem.

German Patent DE 34 13 255 describes a robotic system wherein a robot is supported on a frame which is displaceable on wheels and a workstation is also disposed on a frame also supported on wheels. The workstation is brought into precise engagement with the robot and secured to its frame by raising and lowering the platform of the displaceable unit for engagement with the frame of the robot at the precise location. Accordingly, each time the displaceable platform is modified for the robot, it needs to be disengaged from the robot frame whereby to load further devices or products thereon at specific locations so that the robot can perform a programmed task thereon. This is a very time-consuming operation and each time the mobile unit is removed from the frame of the robot, the robot is maintained idle for at least the time required to connect another mobile frame thereto. This is also a labor-intensive operation which is costly and the robot may be rendered idle for long periods of time.

### SUMMARY OF INVENTION

It is therefore a feature of the present invention to provide a robotic work cell which is comprised of an industrial robot and wherein at least two or more work stations are positioned in the work cell in proximity to the robot and wherein work platforms are detachably secured at the work stations whereby to maintain the robot operative after a programmed task has been completed by simply replacing some or all of the work platforms and instructing the robot to perform another programmed task.

Another feature of the present invention is to provide a robotic work cell with a plurality of work stations, with some of the work stations having detachable work task platforms and other stations may have a platform equipped with a machine which is used for a repetitive task.

Another feature of the present invention is to provide a method of maintaining an industrial robot in operation performing a series of programmed tasks.

Another feature of the present invention is to provide a robotic work cell and method of operation whereby the programmed task is one of a series of programmed tasks which are related and associated with a specific product to be transformed by machines secured to some of said work platforms with others of the work platforms serving as tool supply, material supply or finished product supply platforms.

According to the above features, from a broad aspect, the present invention provides a robotic work cell comprising an industrial robot having at least one articulated robotic arm having a tool engaging end. A robot controller is associated with the robot to cause the robot to effect a programmed task selected from a plurality of programmed tasks stored in a computer memory of the robot controller. At least two work stations are positioned in the work cell in proximity of the robot. Each of the work stations has a work platform detachably secured thereto by connecting means. At least one of the work platforms is a work task platform associated with one of the programmed tasks. Work piece attachment means is provided on the work task platform to secure a work piece at a predetermined location to effect a work task on the work piece by the robot or a work tool secured to the work task platform.

According to a further broad aspect of the present invention there is provided a method of maintaining an industrial robot in operation performing a series of programmed tasks. The method comprises the steps of providing at least two or more fixed work stations at predetermined positions in a work cell of the industrial robot. At least two of the work stations have a work platform detachably secured thereto. One of the work platforms is a work task platform. The work platforms are clamped to the work stations at a precise position. A programmed task is selected from a plurality of programmed tasks by a robot controller to program the robot to effect specific operations with respect to the work platforms. The robot effects specific operations at each work platform as instructed by the series of programmed tasks and wherein the series of programmed tasks are related and associated with a specific work piece to be transformed.

### BRIEF DESCRIPTION OF DRAWINGS

A preferred embodiment of the present invention will now be described with reference to the accompanying drawings in which:

FIG. 1A is a schematic perspective view showing the construction of a robotic work cell having an industrial robot and a plurality of work stations disposed about the robot and detachable work platforms in position to be secured to some of the stations;

FIG. 1B is a schematic perspective view showing a robotic work cell with a modified work station structure;

FIG. 2A is a schematic perspective view similar to FIG. 1 but showing the detachable work task platform engaged with the work stations;

FIG. 2B is another schematic perspective view showing a robotic work cell with all of the work stations engaged by work platforms having a variety of applications and machinery;

FIG. 3 is a block diagram of the system incorporating therein the industrial robot and the work stations and its associated control hardware and software;

FIG. 4 is a fragmented perspective view showing the construction of the attachment frames of the work stations and work platforms;

FIG. 5 is a side view illustrating the frame attachment;

FIG. 6 is an end view illustrating the frame attachment; and

FIG. 7 is a simplified top view showing a modified work cell with a displaceable robot.

### DESCRIPTION OF PREFERRED EMBODIMENTS

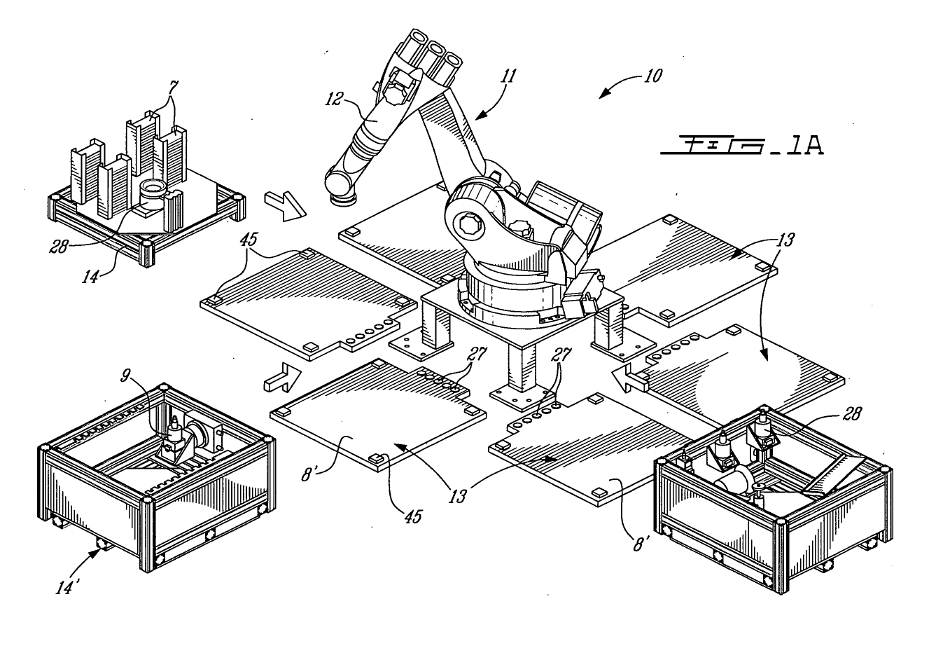

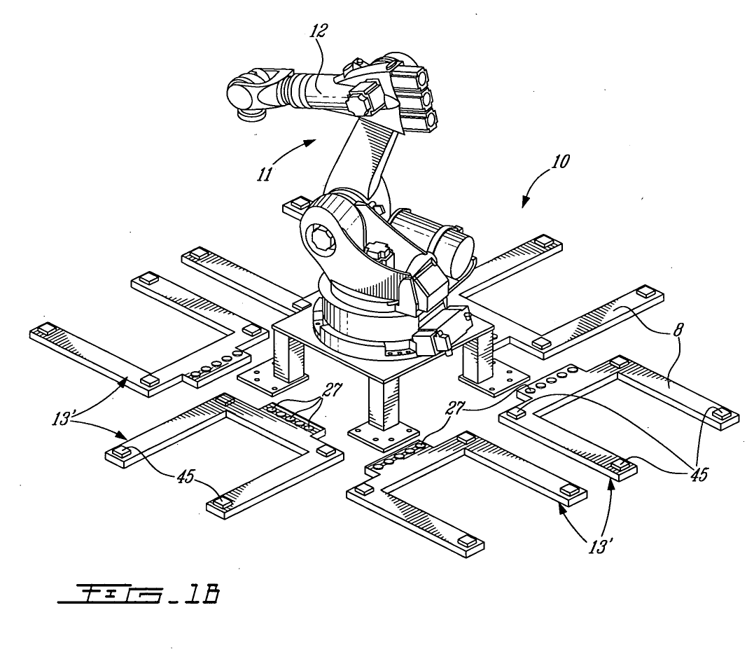

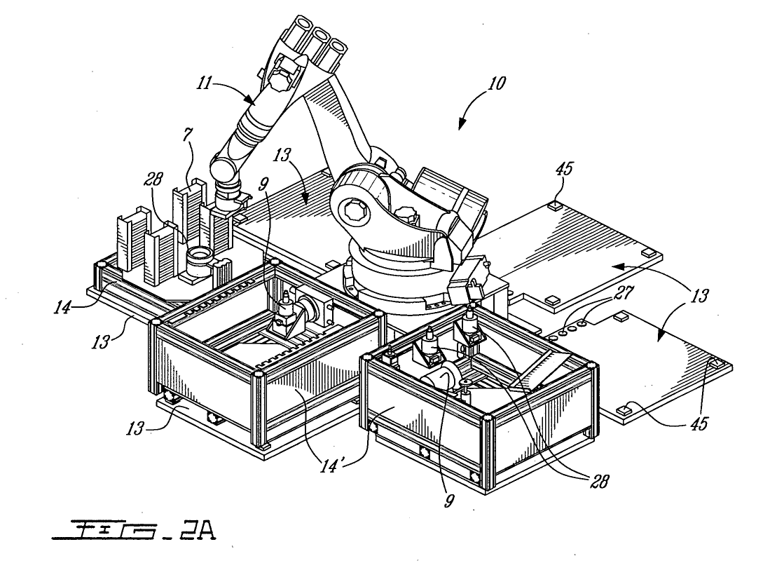

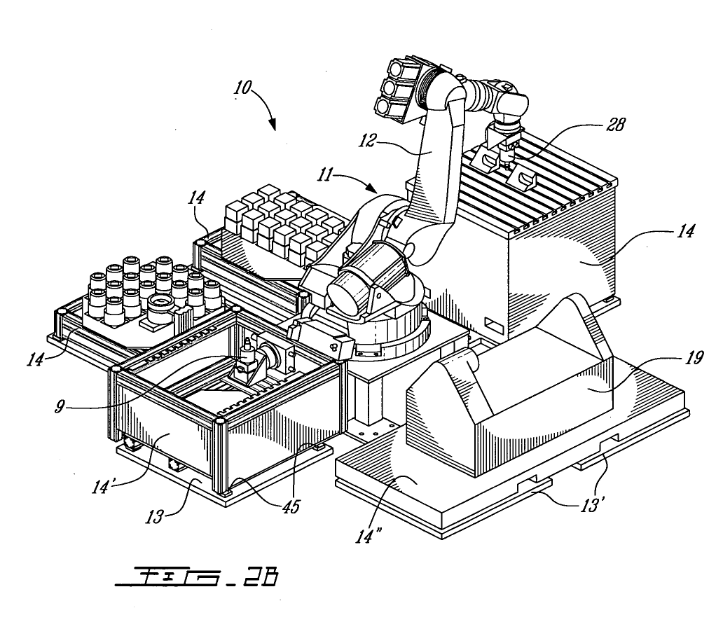

Referring to the drawings and more particularly to FIGS. 1A to 2B, there is shown generally at 10 the robotic work cell of the present invention. It comprises an industrial robot 11 which is provided with an articulated robotic arm 12. At least two work stations, herein a plurality of work stations 13, are positioned in the work cell 10 at specific locations in proximity to the robot 11. As hereinshown there are two work stations on two of opposed sides of the robot with an additional work station disposed on each of the transverse sides. Accordingly, in this configuration there are six work stations 13 disposed about the robot at specific locations. However, this can vary as will be described later.

In the configuration as shown in FIGS. 1A to 2B, all of the work stations 13 are provided with work platforms 14 which are detachable from these work stations. As hereinshown one of the detachable work platforms, namely platform 14′, is a work task platform provided with a work effecting machine or tool 9. As shown in FIG. 2B the work platform 14″ is of larger size and is connectable to two adjacent work stations 13′. FIGS. 2A and 2B show these detachable work task platforms 14, 14′ and 14″ engaged with their associated work stations 13 and 13′. The work stations 13 may have different configurations, examples of which are shown in FIG. 1A and 1B. As shown in FIG. 1B, the work stations 13′ may have a U-shaped frame whereas in FIG. 1A it has a square shaped frame 8′.

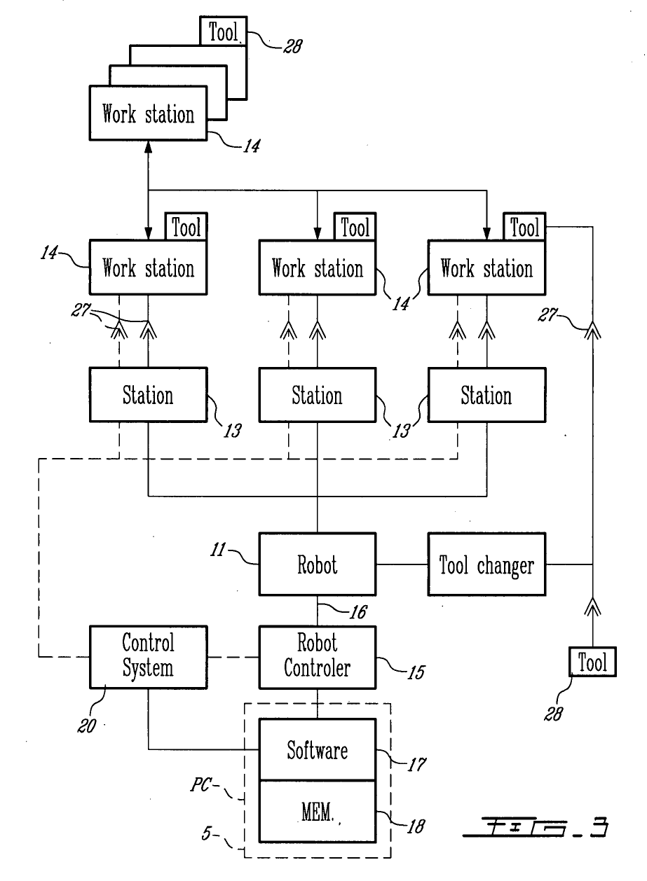

As shown in FIG. 3, a robot controller 15 is connected to the robot 11 by an electrical cable 16. It is also conceivable that the robot controller could have wireless communication with the robot 11. A computer 5 is provided with a memory 18 and a software 17 describing a plurality of programmed tasks whereby to cause the robot and tooles of the platforms to effect an associated job function on a product secured to the work task platforms 14 or a task at an area having a permanent machine, such as the machine 40 illustrated in FIG. 7. Accordingly, the memory of the computer has stored therein a plurality of programmed tasks depending on the assignment to be given to the robot 11 and associated machines or tools for each of the tasks to be performed. A control system 20 also communicates with the software and the robot controller 15 and the various work task platform machines or tools 9 to provide a communication and operating supplies (electricity, pneumatic, vacuum, etc.) link therebetween.

As shown in FIGS. 2B, various work platform configurations can be provided at the work stations in the working environment of the industrial robot 11. These platforms are configured whereby to construct work cells which will accommodate specific tasks to be performed by the industrial robot 11 to transform a work piece 7 (see FIG. 1A). These tasks could be repetitive whereby the robot effects a certain number of specific work functions on the same work piece such as, for example, routing, drilling and trimming a work piece to construct a wood cabinet door. Accordingly, the programmed task for the robot is one of a series of programmed tasks which are related and associated with a specific work piece to produce a finished product. Of course, the robotic arm is controlled by the software to effect its work task function.

FIG. 7 shows a different cell configuration depending on the scheduled work tasks of the robot 11 which is herein shown secured to a displaceable carriage 21 mounted on guide rails 22 whereby the robot is displaceable to predetermined locations associated with each of the work stations 13 of a plurality of work stations. As hereinshown, there are several work stations 13 disposed in side-by-side relationship on opposed sides of the guide rails 22 and an additional work stations 40 and 41 on opposed sides of the guide rails. Station 40 is a fixed work station which does not change while station 41 is provided with a removable work platform secured to the two work stations 13′″.

A fixed work area 19 can also be disposed at the end of the guide rails 22 for storing finished products 33, or other purpose. FIG. 7 shows an example of how the robotic work cell 10 of the present invention can be configured, but a multitude of other configurations are possible, as it becomes obvious to a person skilled in the art.

Further connection means 27, (see FIGS. 1A, 1B and 2A) also herein schematically illustrated, provide for the proper operational supply sources for one or more machine or tool 9 which may be supplied on the work task platforms 14′. The supplies could be electrical or pneumatic or any other required supply source.

Referring again to FIG. 7, there is shown still further modifications of a robotic work cell 10 constructed in accordance with the present invention. As hereinshown, at least one of the work stations, herein station 13″, is displaceable from a fixed, predetermined position, as shown by reference numeral 30, to a part handling position 31 where a work platform 14 can be reconfigured or removed for reconfiguration and replaced. A zone or station 32 can also be provided all along one end of the cell 10 to provide for part handling or for other uses. For example, a conveyor could be disposed at the station 32 whereby the robot could discharge parts which have been machined directly thereon for transportation to a remote area. The fixed work station 19 can consist of a piece of equipment which is very large or very heavy and which is not easily displaceable. The station 19 can also be used to store work pieces to be transformed and disposed at predetermined locations whereby the robot retrieves them to effect a specific work task and discharge them on the conveyor 32. Of course, with the work cell concept of the present invention one can see that an industrial robot 11 can be kept in operation performing different programmed tasks or job functions for different types of work pieces to be transformed.

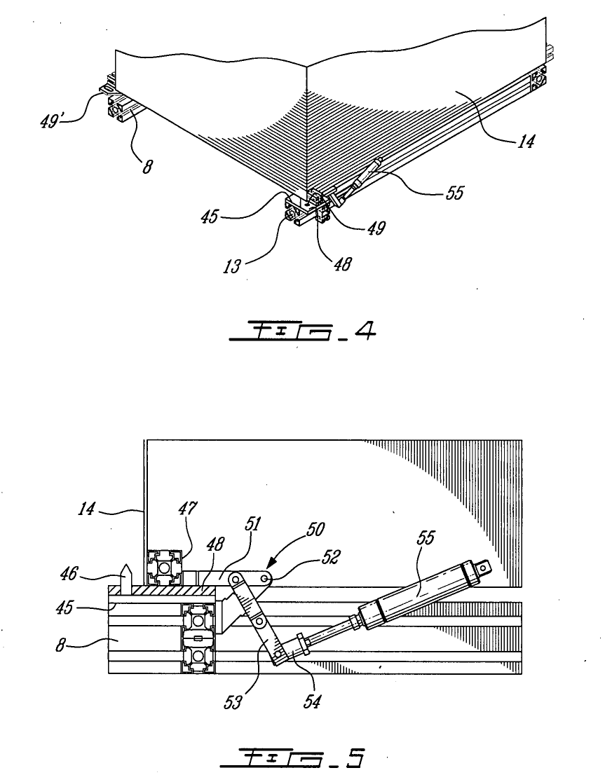

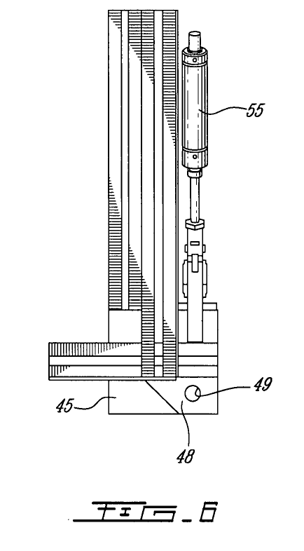

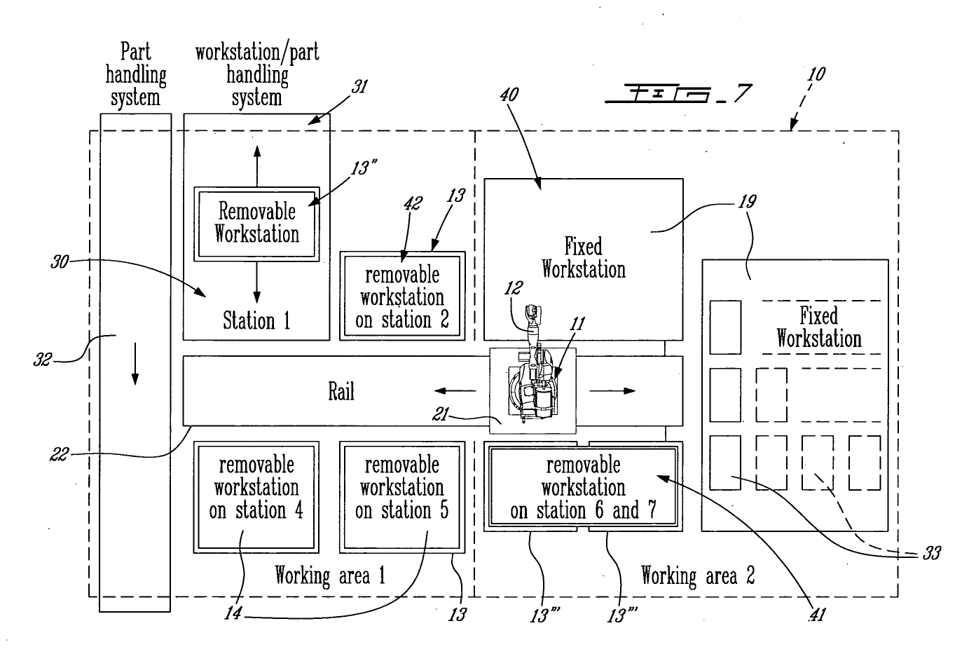

Referring now to FIGS. 4 to 6 there will be described the manner in which a work platform 14 is connected to a work station 13. As shown in these drawings the connecting frame 8 of the work stations 13 are extruded metal rods anchored in a floor surface to be immovable. Each of these rods are provided with a station positioning and connecting plate 45 at predetermined positions, herein at opposed ends of the frames 8. These station positioning plates 45 may be provided with location pins 46 which project vertically upwards therefrom. The work platforms 14 also have a connecting frame 47 which is provided with positioning plates 48 secured thereto. The plates 48 are provided with an alignment hole 49 therein, as better seen in FIG. 6, and disposed to receive an associated one of the pins 46 when the work platform 14 is positioned over the frame 8 of the work station. These frames are usually handled by a fork lift device which is operated by an operator person.

When the work platform is lowered onto the work station frame 8 the pins 46 enter the holes 49 and positions the plates in perfect alignment with one another. A clamping mechanism 50 then clamps these plates together to provide an immovable connection.

The clamping mechanism 50 is secured to the station frame 8 at opposed corners thereof, one being shown in FIG. 4, and is provided with a clamping bar 51 which is pivoted on pivot 52 and connected to a link arm 53 which is secured to a piston rod end 54. By actuating the piston 55 the clamp arm 51 can be disposed in clamping engagement with the plates 45 and 48 or be retracted therefrom to permit the removal of the work platform from the work station.

As shown in FIG. 4 the holes 49, for example hole 49′, may be formed as a slot whereby to provide for lateral adjustment with the pins. Also, the pins 46 may be provided as a separate part and engaged with both plates 48 and 45 after the work platform has been positioned on the work station whereby to provide adjustment. Of course, in such a configuration the plate 45 would also have a slot therein. The bolt 46 would have to be provided with a bolt head.

In summary, the work cell concept of the present invention provides a method of maintaining an industrial robot in operation performing programmed tasks associated with the manufacture of different products. The method comprises providing at least two work stations at predetermined positions in a work cell of the industrial robot -with a work platform detachably secured to the work stations. The work platform is removable from the work station by an easy disconnection of the frames of the work platform and the work station. The work platforms can be reconfigured at a remote part handling location or the work station could be made movable to be displaced with the platform to a part handling location, as shown in FIG. 7. A part change is effected to the work platform and it is then reconnected to its specific work station in the work cell or another station in accordance with the program stored in the computer. A programmed task is selected by an operator and the controller takes over the operation of the cell. On the other hand, the operator can select solely the program which is dedicated to the configuration of the existing platforms 14 present in the cell 10. The robot effects specific operations at each work platform as instructed by the series of programmed tasks stored in the memory of the computer.

As previously described, the robotic work cell of the present invention is a flexible modular work cell having different stations arranged in different configurations about the industrial robot with the robot being fixed or displaceable. An advantage of this system is that it provides for expansion of the work cell, as herein illustrated. With the robotic cell of the present invention, it is no longer necessary for a company to have a large production of a product with repetitive tasks in order to justify the acquisition of an industrial robot.

It is within the ambit of the present invention to cover any obvious modifications over the preferred embodiments described herein, provided such modifications fall within the scope of the appended claims.

1. A robotic work cell comprising an industrial robot having at least one articulated robotic arm having a tool engaging end, a robot controller associated with said robot to cause said robot to effect a programmed task selected from a plurality of programmed tasks stored in a computer memory, at least two work stations are positioned in said work cell in proximity of said robot, each said work stations having a work platform detachably secured thereto by connecting means, at least one of said work platforms being a work task platform associated with one of said programmed tasks, work piece attachment means on said work task platform to secure a work piece at a predetermined location to effect a work task on said work piece by said robot or a work tool secured to said work task platform.

2. A robotic work cell as claimed in claim 1 wherein there are a plurality of said work stations disposed at fixed predetermined locations with respect to said industrial robot, said articulated robotic arm being displaceable for access to designated ones of said work platforms at each said plurality of said work stations to effect said programmed tasks associated with said work piece.

3. A robotic work cell as claimed in claim 2 wherein said industrial robot is secured at a fixed location with said plurality of said work stations being positioned about said industrial robot also at fixed locations.

4. A robotic work cell as claimed in claim 3 wherein said connecting means is constituted by two or more frame positioning plates secured to a connecting frame of each said work platform, said frame positioning plates having an alignment hole therein, and two or more alignment pins secured to each said work station and disposed to be received in an associated one of said alignment hole provided in said frame positioning plates, and clamping means to clamp said frame positioning plates against said work station when positioned in alignment thereover with said pins extending in said alignment holes.

5. A robotic work cell as claimed in claim 4 wherein said work stations are also provided with station positioning plates at predetermined positions, said pins being secured to a respective one of said station positioning plates and extending vertically thereabove, said clamping means being a piston operated clamp secured to said work stations adjacent said station positioning plates and adapted to engage a top face of said frame positioning plates when disposed over said station positioning plates to apply clamping pressure to immovably connect said work platform to said work station.

6. A robotic work cell as claimed in claim 5 wherein there are four of said frame and station positioning plates disposed at spaced apart locations to immobilize said work platform on said work station at a precise location.

7. A robotic work cell as claimed in claim 2 wherein at least one of said plurality of work stations has a work platform equipped with a machine which performs a repetitive programmed task.

8. A robotic work cell as claimed in claim 2 wherein said industrial robot is secured to a displaceable carriage mounted on guide rails whereby said robot is displaceable to predetermined locations associated with each said work station of said plurality of work stations.

9. A robotic work cell as claimed in claim 2 wherein at least one of said work platform is displaceable from said work station to a part handling system location to effect a change to said work platform.

10. A robotic work cell as claimed in claim 2 wherein some of said work platforms are work piece, product or parts support platforms associated with said at least one work task platform.

11. A robotic work cell as claimed in claim 7 wherein there is further provided supply connectors between said platform support base and said work task platform to connect work task effecting operational supplies to one or more machine or tool associated with said work task platform.

12. A robotic work cell as claimed in claim 8 wherein at least some of said work task platforms are provided with tools to effect said programmed tasks associated therewith, said robot controller selecting a specific programmed task from said stored programmed task to automatically control said robotic arm to connect to a desired one of said one or more tools to effect a specific work task on a work piece secured to said work task platform.

13. A robotic work cell as claimed in claim 8 wherein a common product to be transformed is associated with two or more of said work task platforms of two or more of said work stations, each work station of said two or more work stations being associated with a specific different work task on said common work piece.

14. A method of maintaining an industrial robot in operation performing a series of programmed tasks, said method comprising the steps of:
i) providing at least two or more fixed work stations at predetermined positions in a work cell of said industrial robot, at least two of said work stations having a work platform detachably secured thereto, one of said work platforms being a work task platform,
ii) clamping said work platforms to said work stations at a precise position,
iii) selecting a programmed task from a plurality of programmed tasks by a robot controller to program said robot to effect a specific operation with respect to said work platforms,
iv) said robot effecting specific operations at each said work platforms as instructed by said series of programmed tasks and wherein said series of programmed tasks are related and associated with a specific work piece to be transformed.

15. A method as claimed in claim 14 wherein said step (i) comprises providing a plurality of fixed work stations in said work cell about said industrial robot, at least one of said work stations having a machine to effect fixed work function.

16. A method as claimed in claim 14 wherein there is further provided the step of disconnecting said work task platforms from said work stations and transporting said work platforms to a remote location.

17. A method as claimed in claim 14 wherein said step (iv) comprises automatically displacing said industrial robot to at least some of said fixed work stations.

18. A method as claimed in claim 14 wherein said robot is provided with an articulated robotic arm, said step (iv) comprising said robotic arm securing a tool thereto from a tool location provided with one of said work platforms, effecting a programmed job function with said tool on a work piece secured at a predetermined location on one of said work platforms, and returning said tool to said tool location.

19. A method as claimed in claim 14 wherein said step (i) comprises positioning said work platforms over associated ones of said work stations by aligning frame positioning plates of each said work platform over station positioning plates of said associated one of said work stations, and effecting step (ii) to clamp said plates together at said precise position.

20. A method as claimed in claim 19 wherein said frame positioning plates are each provided with an alignment hole, said station positioning plates each having alignment pins, said step of positioning said plates in alignment comprising aligning said positioning holes of said frame positioning plates over said alignment pins and lowering said work platform to cause said pins to enter said holes and automatically align said plates at said precise position.
